(19) United States
(12) Patent Application Publication
(10) Pub. No.: US 2005/0034574 A1
(43) Pub. Date: Feb. 17, 2005

(54) Hand tool having an extendable handle structure

(76) Inventor: Chih - Ching Hsien, Taichung (TW)

Correspondence Address: Chih - Ching Hsien, 58, MA YUAN WEST ST., TAICHUNG, TW

(21) Appl. No.: 10/643,482

(22) Filed: Aug. 15, 2003

(51) Int. Cl. B25B 7/02

(52) U.S. Cl. 81/415

(57) ABSTRACT

A hand tool includes two half portions pivotally connected with each other, and two opposite magnetic members each mounted in a respective one of the two half portions. The two opposite magnetic members are repulsive with each other, so that the two half portions are extended outward relative to each other by the repulsive action between the two magnetic members.

### BACKGROUND OF THE INVENTION

1. Field of the Invention

The present invention relates to a hand tool, such as a pair of pliers or the like, and more particularly to a hand tool having an extendable handle structure that can be extended outward automatically.

2. Description of the Related Art

A conventional hand tool, such as a pair of pliers or the like, in comprises two half portions pivotally combined with each other by a pivot member. Each of the two half portions has a first end formed with a jaw and a second end formed with a handle. In operation, the user has to initially extend the two half portions outward relative to each other to open the jaws of the two half portions and then contract the two half portions inward relative to each other to close the jaws of the two half portions so as to clamp a workpiece, thereby causing inconvenience to the user in operation of the conventional hand tool.

### SUMMARY OF THE INVENTION

The primary objective of the present invention is to provide a hand tool having an extendable handle structure that can be extended outward automatically.

Another objective of the present invention is to provide a hand tool that can be extended outward automatically by the repulsive force between the two opposite magnetic members, thereby facilitating the user operating the hand tool.

A further objective of the present invention is to provide a hand tool, wherein the two opposite magnetic members can be used to attract a small part, such as the screw, nut or the like, thereby preventing the small part from being lost.

A further objective of the present invention is to provide a hand tool, wherein when not in use, the hand tool 10 can be temporarily attached on a magnetic article, such as the workpiece or the like, by the magnetic force of the two opposite magnetic members, thereby facilitating the user operating the hand tool.

A further objective of the present invention is to provide a hand tool, wherein each of the two magnetic members is closely mounted in the receiving space of the respective half portion, thereby preventing the oil or dust from being deposited on the surface of the hand tool.

In accordance with the present invention, there is provided a hand tool, comprising:
two half portions pivotally connected with each other; and
two opposite magnetic members each mounted in a respective one of the two half portions;
wherein, the two opposite magnetic members are repulsive with each other, so that the two half portions are extended outward relative to each other by the repulsive action between the two opposite magnetic members.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a hand tool in accordance with the preferred embodiment of the present invention;

FIG. 2 is an exploded perspective view of the hand tool as shown in FIG. 1;

FIG. 3 is a top plan view of the hand tool as shown in FIG. 1;

FIG. 4 is a schematic operational view of the hand tool as shown in FIG. 3 in use; and

FIG. 5 is a perspective view of a hand tool in accordance with another embodiment of the present invention.

### DETAILED DESCRIPTION OF THE INVENTION

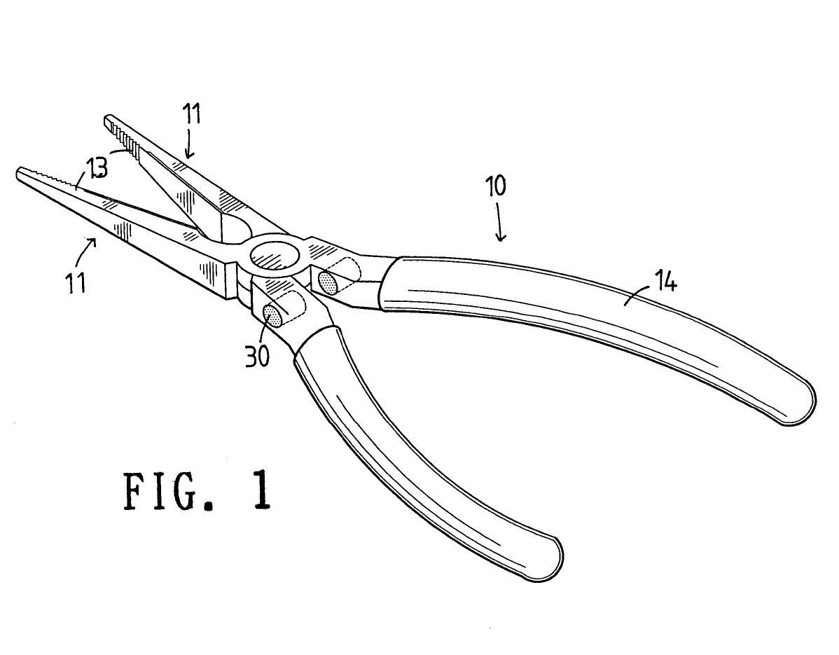

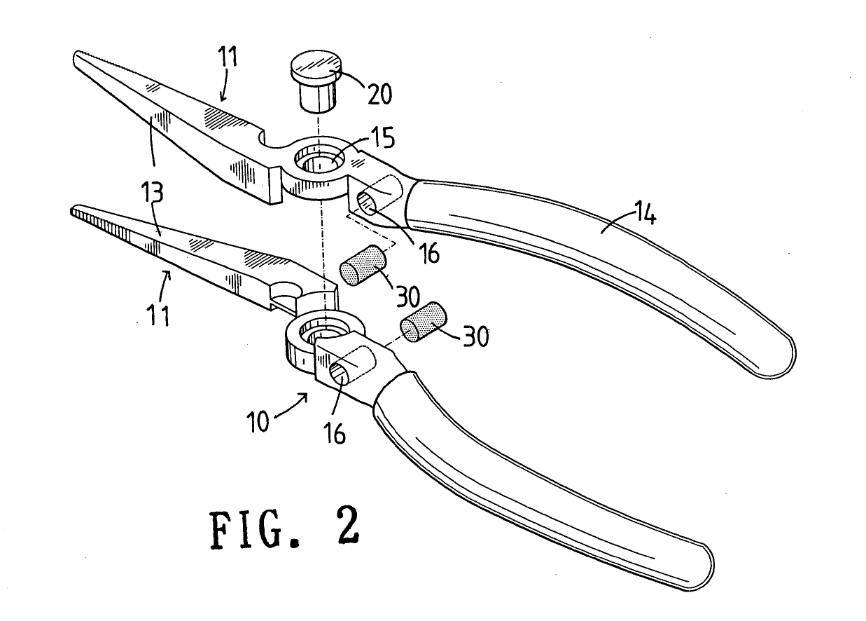

Referring to the drawings and initially to FIGS. 1-3, a hand tool 10, such as a pair of pliers or the like, in accordance with the preferred embodiment of the present invention comprises two half portions 11 pivotally connected with each other.

Each of the two half portions 11 has a first end formed with a jaw 13, a second end formed with a handle 14, and a mediate portion formed with a pivot hole 15. The hand tool 10 further comprises a pivot pin 20 extended through the pivot hole 15 of each of the two half portions 11, so that the two half portions 11 are pivotally connected with each other.

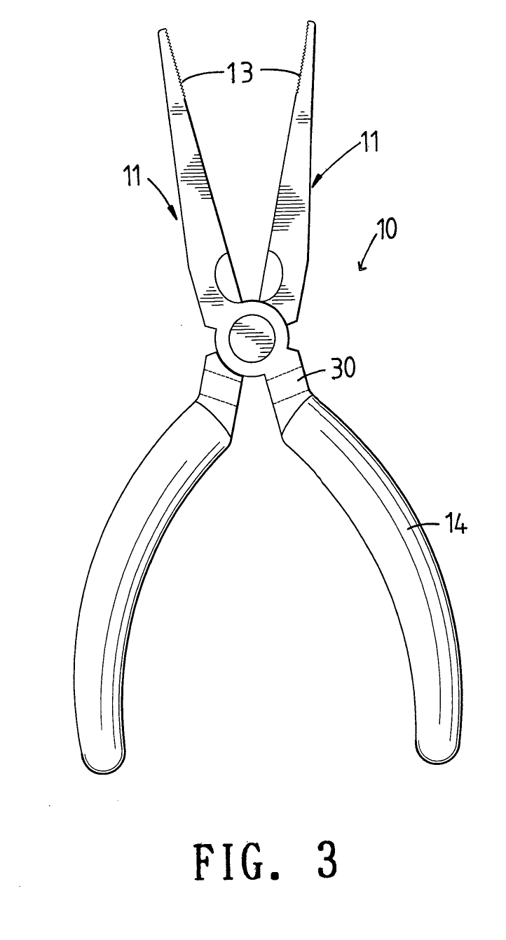

The hand tool 10 further comprises two opposite magnetic members 30 each mounted in a respective one of the two half portions 11. The two opposite magnetic members 30 are repulsive with each other, so that the two half portions 11 are extended outward relative to each other at the normal state when not in use as shown in FIG. 3. Preferably, each of the two half portions 11 has a side formed with a receiving space 16 to fully receive the respective magnetic member 30, so that each of the two opposite magnetic members 30 is entirely hidden in a respective one of the two half portions 11. Preferably, the receiving space 16 is formed on the mediate portion of each of the two half portions 11 and is located adjacent to the pivot hole 15 of each of the two half portions 11. Preferably, the receiving space 16 is located at a front end of the handle 14 of each of the two half portions 11.

In practice, as shown in FIG. 3, at the normal state, the two half portions 11 are extended outward relative to each other by the repulsive action between the two opposite magnetic members 30.

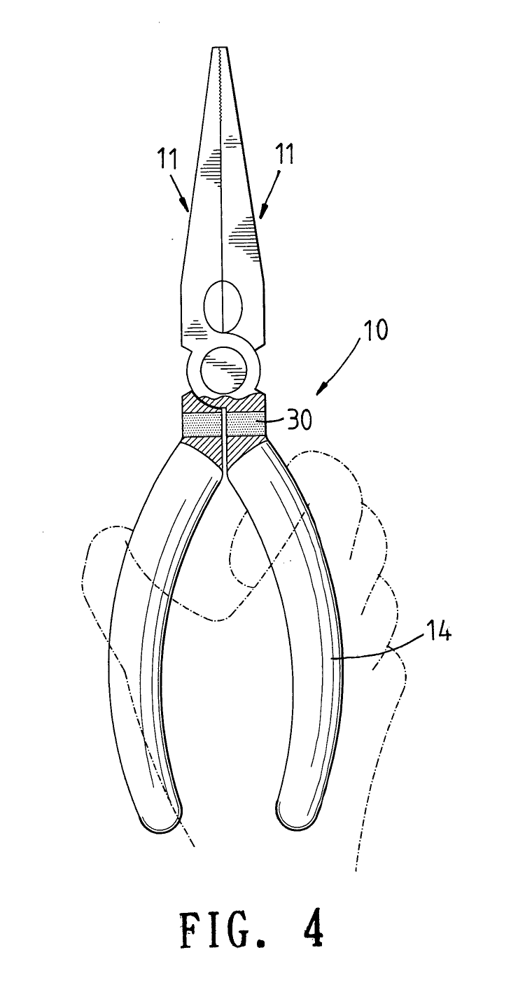

In use, as shown in FIG. 4, the user's one hand exerts a force on the handles 14 of the two half portions 11 to press the handles 14 to move toward each other so as to overcome the repulsive force between the two opposite magnetic members 30, so that the jaws 13 of the two half portions 11 can be moved toward each other so as to clamp a workpiece.

On the contrary, after the force applied on the handles 14 of the two half portions 11 is removed, the two half portions 11 are again extended outward relative to each other by the repulsive force between the two opposite magnetic members 30.

Accordingly, by such an arrangement, the hand tool 10 can be extended outward automatically by the repulsive force between the two opposite magnetic members 30, thereby facilitating the user operating the hand tool 10. In addition, the two opposite magnetic members 30 can be used to attract a small part, such as the screw, nut or the like, thereby preventing the small part from being lost. Further, when not in use, the hand tool 10 can be temporarily attached on a magnetic article, such as the workpiece or the like, by the magnetic force of the two opposite magnetic members 30, thereby facilitating the user operating the hand tool 10. Further, each of the two magnetic members 30 is closely mounted in the receiving space 16 of the respective half portion 11, thereby preventing the oil or dust from being deposited on the surface of the hand tool 10.

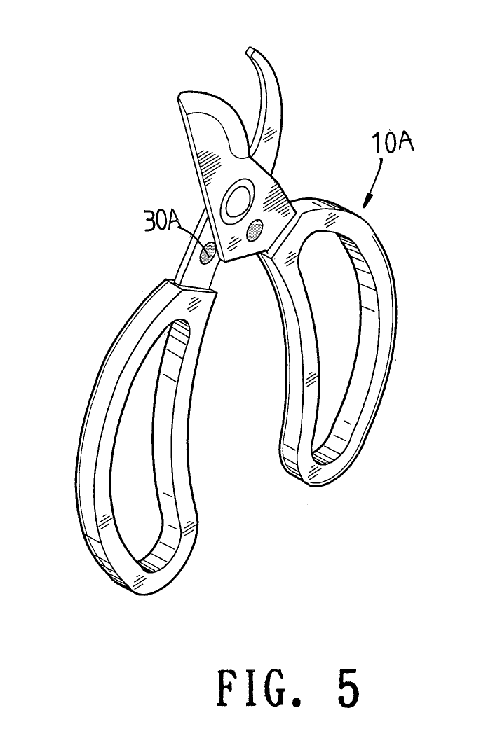

Referring to FIG. 5, the hand tool 10A in accordance with another embodiment of the present invention is available for a pair of garden pliers and comprises two opposite magnetic members 30A repulsive with each other.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A hand tool, comprising:
two half portions pivotally connected with each other; and
two opposite magnetic members each mounted in a respective one of the two half portions;
wherein, the two opposite magnetic members are repulsive with each other, so that the two half portions are extended outward relative to each other by the repulsive action between the two opposite magnetic members.

2. The hand tool in accordance with claim 1, wherein each of the two half portions has a side formed with a receiving space to receive the respective magnetic member, so that each of the two opposite magnetic members is entirely hidden in a respective one of the two half portions.

3. The hand tool in accordance with claim 2, wherein each of the two half portions has a first end formed with a jaw, a second end formed with a handle, and a mediate portion formed with a pivot hole.

4. The hand tool in accordance with claim 3, wherein the receiving space is formed on the mediate portion of each of the two half portions.

5. The hand tool in accordance with claim 3, wherein the receiving space is located adjacent to the pivot hole of each of the two half portions.

6. The hand tool in accordance with claim 3, wherein the receiving space is located at a front end of the handle of each of the two half portions.

7. The hand tool in accordance with claim 2, wherein each of the two magnetic members is closely mounted in the receiving space of the respective half portion.
